(19) United States
(12) Patent Application Publication
(10) Pub. No.: US 2014/0164084 A1
(43) Pub. Date: Jun. 12, 2014

(54) SKU-LEVEL CARD LINKED OFFER PLATFORM

(71) Applicants: Brett Battles, Menlo Park, CA (US); Nikita Tovstoles, San Jose, CA (US)

(72) Inventors: Brett Battles, Menlo Park, CA (US); Nikita Tovstoles, San Jose, CA (US)

(21) Appl. No.: 13/972,491

(22) Filed: Aug. 21, 2013

Related U.S. Application Data
(60) Provisional application No. 61/691,599, filed on Aug. 21, 2012.

(51) Int. Cl. G06Q 30/02

(52) U.S. Cl. CPC G06Q 30/0215
USPC 705/14.17

(57) ABSTRACT

A system and method to provide item level purchase incentives directly to consumers are fully disclosed. Item level offers may include brand or product SKU-specific offers and rewards. In some embodiments, incentives may be credited directly to the consumer's card or bank account without any action required from the consumer subsequent to purchasing the product. The platform will evaluate potential offers and incentives according to a rules engine. The platform also maps the brand's authorized dealers by location so that offers can be targeted to consumers shopping at that location or who live within a certain distance of that location, for example, in addition to targeting by demographic, household income, past spending patterns, etc. Typically, the platform integrates directly with credit card issuer's systems sending the validated transaction information to the card issuer with an amount to be credited on that card or account.

### RELATED APPLICATION

This application claims the benefit under 35 USC 119 of U.S. Provisional Application No. 61/691,599 filed on Aug. 21, 2012 and entitled “SKU-LEVEL CARD LINKED OFFER PLATFORM”, which is expressly incorporated herein by reference in its entirety.

### FIELD

The present disclosure relates to systems and methods for providing incentives for consumer purchases. In some embodiments, the incentives are specific to certain products or marketing targets. In some embodiments, consumer purchases are tracked at the point of sale.

### BACKGROUND OF THE INVENTION

Cash-back rewards and card-linked offer programs have been successfully deployed by credit card companies to activate consumers and drive purchase behavior. Originally developed by card issuers as part of their loyalty initiatives, these programs would provide an incentive—say 1% cash back on any purchase, discount coupons, instant rebates, even airline miles,—to card members for using a specific credit card in their purchases. The programs evolved to now include merchant-specific offers: a card member will typically receive an incentive for purchasing products from partner merchants when using a specific card (for instance, $X back or % Y discount on any purchase at Retailer Z). Typically, these merchant-based offers are target-marketed (e.g., by demographic, by location, purchase history) to the card member base through email and direct mail. These programs have proven to activate consumers, impact their purchase behavior and drive more sales; merchants and credit card issuers see more sales.

### SUMMARY OF THE INVENTION

Incentives are extended to consumers using item level offers and targeted using various channels according to the present invention. Item level offers may include brand or product SKU-specific offers and rewards. Further, the present invention provides the ability to do targeted marketing around those products to drive consumer purchases at retail and the ability to track sales at the point of sale. Unlike typical marketing alternatives, vendors will now get complete control over the campaign, the ability to target market and clear visibility on impact of the campaign, throughout the purchasing process. Instead of relying on poorly targeted co-op funds and leaving it up to them to effectively promote the brand's products, brands can now take control by targeting consumers with a post-sale offer, while driving sales into authorized dealers to preserve channel relationships.

Incentives may be credited directly to the consumer's card or bank account without any action required from the consumer subsequent to purchasing the product. This structure allows campaign sales to be observed directly and fosters better sales and brand loyalty.

The platform also maps the brand's authorized dealers by location so that offers can be targeted to consumers shopping at that location or who live within a certain distance of that location, for example, in addition to targeting by demographic, household income, past spending patterns, etc.

The platform will evaluate potential offers and incentives according to a rules engine. In some embodiments, the platform may validate and verify transactions in real-time, for example, by interfacing with APIs during the checkout flow. In other embodiments, the platform will validate and verify transactions asynchronously to the tender process.

The platform may fund the reward as part of the tender process or asynchronously (post-sale offer redemption). Typically, the platform integrates directly with credit card issuer's systems sending the validated transaction information to the card issuer with an amount to be credited on that card or account. Where sufficient information about the cardholder is known, the platform may fund the card directly. For these embodiments, the platform may remove the CC issuer from the back-end flow completely.

### BRIEF DESCRIPTION OF THE DRAWINGS

For purpose of explanation, several embodiments of the disclosure are set forth in the following figures.

FIG. 1 depicts a flow chart illustrating the platform overview of the SKU-Level cash back rewards platform.

FIG. 2 depicts a flow chart illustrating a detailed process workflow according to some embodiments.

FIG. 3 depicts a table representing a sample data field which stores point of sale transaction information.

FIG. 4 depicts a diagram illustrating an exemplary computing system for execution of the operations comprising various embodiments of the disclosure.

### DETAILED DESCRIPTION

A platform, disclosed herein, extends incentives in 2 important ways: (1) it now brings this capability to product brands by introducing SKU or item level card linked offers; (2) it distributes the offers beyond merely relying on credit card partners by implementing target marketing (demographically and location specific) of the offers through various channels (social media, mobile alerts, etc).

### I. Extending Cash Back Rewards, Credit Card and Other Incentive Programs to Brand Promotions at the SKU Level

The platform described herein provides a turnkey system to take these card-based programs to the next level: brand or product SKU-specific card linked offers and cash back rewards for manufacturers and consumer brands. The platform provides the ability to offer a targeted cash-back style incentive on specific brands, product SKUs or product families sold at a brand's authorized retailers. The platform further provides the ability to do targeted marketing around those products to drive consumer purchases at retail—plus the ability to track sales at POS.

The platform puts this powerful tool in the hands of brand marketers: allowing them for the first time to create specific cash-back rewards for their products, targeting them for promotion to card holders, driving the purchase into local authorized retailers, and having the incentive credited directly to the consumer's card or bank account—without the consumer needing to do anything (other than purchase the product). This will allow manufacturers to better target their promotions AND get direct and clear visibility on campaign sales pull-through at the SKU level, without discounting prices. Merchants will enjoy increased category sales and basket sizes while credit card partners will see increased transactions and better brand loyalty.

### II. Embodiments of the Invention

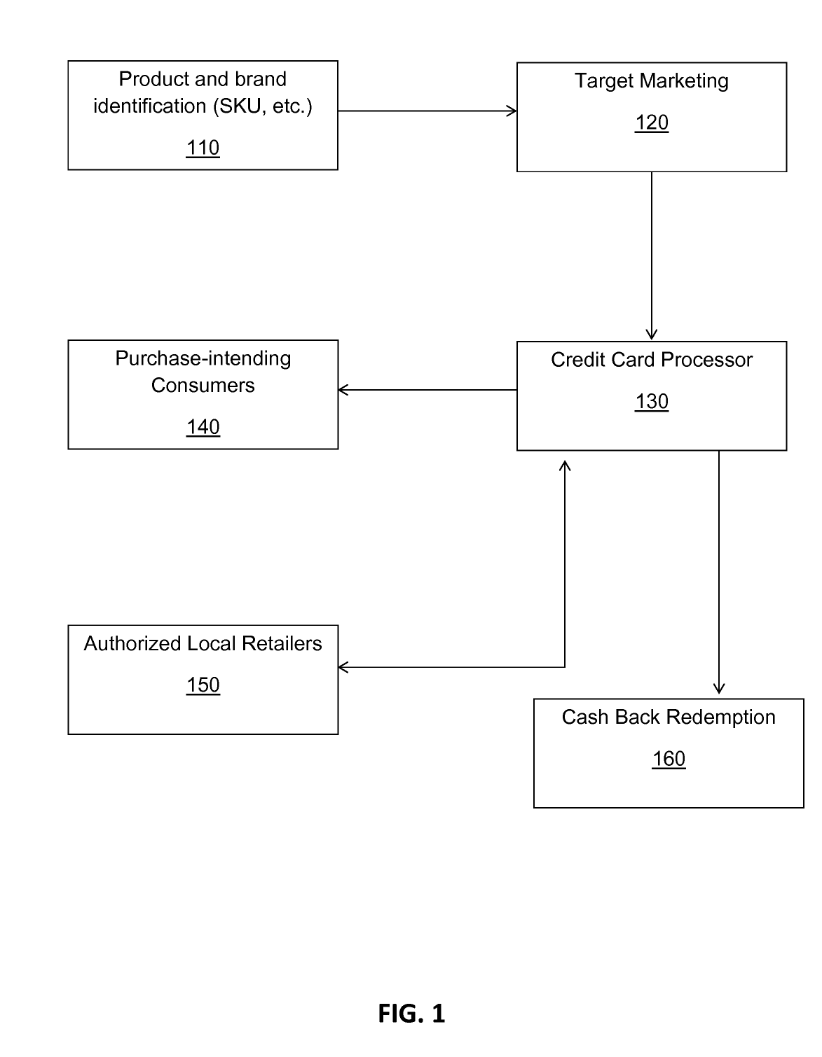

Say that as part of a new product launch, a brand manager wants to create a targeted consumer promotion at the SKU level for a specific product 110. With the platform disclosed herein, they could create a cash-back incentive for card members of the platform's financial services partners for the purchase of that product through the brand's authorized retailers. Unlike the brand's typical marketing alternatives (e.g., high-level brand ads, co-op funds disbursed to retailers) they will now get complete control over the campaign, the ability to target market and clear visibility on impact of the campaign—all the way through to the cash register. The key components of the process are shown in FIG. 1 and include:

Creating/Target Marketing/Syndicating the Offers—At Target Marketing 120, the platform disclosed herein distributes offers to targeted consumers 140 across a variety of channels including (a) mailing lists of the platform's credit card partners (including targeting based on location and past purchase behavior), (b) social media (Facebook and Twitter API integration), (c) geo-targeted mobile applications (pushing offers to consumers when they are in the physical proximity to a brand's authorized merchant.) The platform also maps the brand's authorized dealers 150 by location (e.g., zip code) so that offers can be targeted to consumers shopping at that location, who live within 3 miles of that location, etc—in addition to targeting by demographic, household income, past spending patterns, etc.

Validating and verifying the purchase—the platform ingests automatically point-of-sale (POS) data from either bricks and mortar register systems or ecommerce shopping cart systems and using a rules engine for each program of the platform, automatically determines whether SKUs purchased in each transaction qualify for the offer and if so, how much. The platform may validate and verify either real-time or asynchronous to the tender process 130. For instance, a POS system or an ecommerce shopping cart may interface with the system through APIs whereby the offer information is transmitted back to the POS or shopping cart during the checkout flow. Alternatively, sales-out data is uploaded to the system electronically e.g., on a nightly basis, and the system automatically validates and verifies transactions by scanning the data line item by line item, applying a set of program rules (SKU, location, customer, etc) as described below.

Funding the reward—the platform may fund the reward either in real time as part of the tender process by decreasing the amount paid for the product, or asynchronous to the tender process (e.g., post-sale offer redemption). For post-sale redemption, the platform will typically fund the offers directly e.g., by funding a user's PayPal account, by issuing a pre-paid VISA card, or by crediting a consumer's credit card or bank account directly. It can even accommodate reward payments via gift cards, airline miles, and other non-cash vehicles. More typically, the platform integrates directly with credit card issuer's systems sending the validated transaction information 160 to the card issuer with an amount to be credited on that card or account.

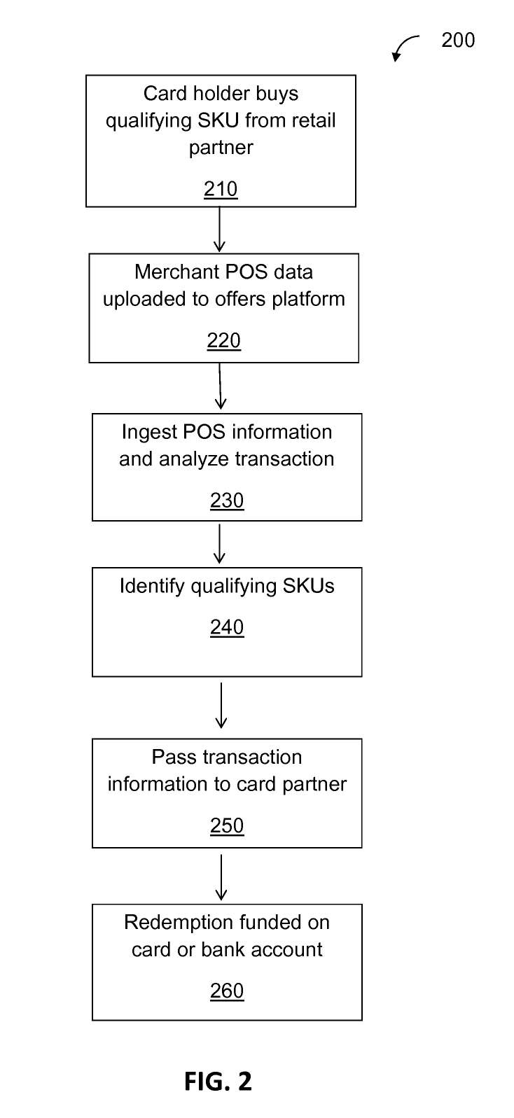

A more detailed description of a ‘typical’ process flow is shown in FIG. 2 and is described step by step below. Note that this flow does not represent all possible features/uses of the platform but merely shows a typical use-case. This use-case is based on a partnership with a payment entity such as a credit card company or online payment service and focuses on the second two of the major buckets describes above (i.e., omits how offers are syndicated via targeted ads or direct marketing channels).
1) Card holder buys a qualifying SKU from a retailer at step 210.
2) Retailer sends POS data to the platform either nightly or weekly (TBD) at step 220.
   The POS feed is typically a batch extract by the merchant from their data warehouse or elsewhere and sent to the platform as a CSV either via secure HTTP, FTP or email
   The retailer does not need to try and ‘filter’ the data before they send it to the platform by trying to find only SKUs that qualify or only brands that qualify; they merely need to send the raw data (perhaps filtering by category or store department) to the platform.
3) The data is automatically ingested by the platform and processed at the SKU and transaction level to look for qualifying SKUs and applying program rules to determine incentive amounts at step 230.
4) The platform will determine which transactions contained the qualifying SKUs from the brand who is sponsoring the reward at step 240.
5) The platform may pass that information to the card partner along with whatever ancillary information the card partner needs to determine precisely who the card member was, what their account number is, etc so that card partner can fund the cash-back reward (CBR) to the member's account at step 250.
6) CBR deposited to card holder who purchased the qualifying SKU with the qualifying transaction at step 260.

In some embodiments, a batch process is executed. In other embodiments, the process occurs in real time. With next generation POS systems (or with suitable modification to existing ones) the POS system calls out to the platform using an API protocol, and queries the platform in real time saying “I'm here at this Store A location, a customer is buying SKU 12345 and using a credit card—is there an award available”. Alternatively, this may also be executed with an ecommerce shopping cart. In this way, the validation and the offer award may be done in real time while the customer is checking out. Moreover, it does not have to be a cash back reward or a credit on the account—the platform may communicate to the POS system to decrement to tendered amount by $X, the award amount.

In some embodiments, the platform funds the card directly. For example, in some embodiments, information about the cardholder may not be known at the time of purchase (e.g., no PII is received so the 16 digits of the credit card, etc., are not known). For this embodiment, the platform captures the CC authorization ID for that transaction and uses that as the indexing key with the credit card company. However, in other embodiments, additional information is captured. For these embodiments, the platform may remove the CC issuer from the back-end flow completely. For instance, if the 16 digit CC number is known, the platform may put funds (e.g., $50) on that card directly.

### III. Database Examples

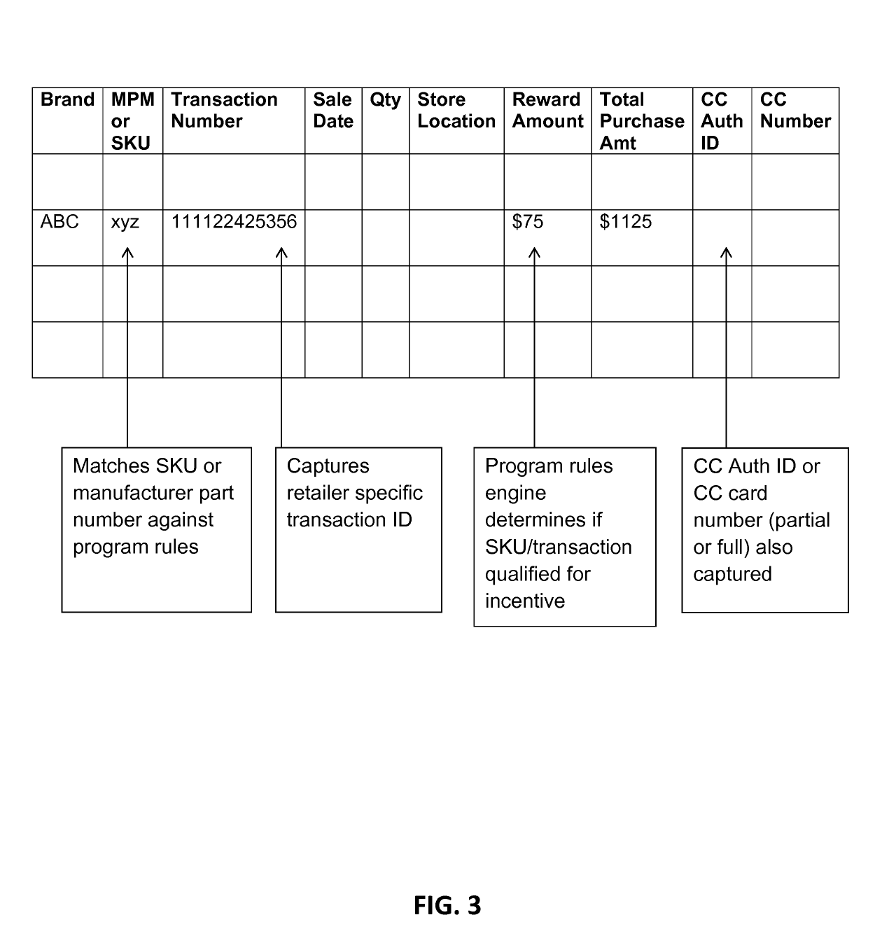

FIG. 3 shows a schematic of one embodiment for the POS data fields from which validation/verification and interfacing for funding with a CC issuer (if that was the model employed) may occur. For each retailer, transaction level data includes SKUs purchased, store locations, dates, etc as depicted in FIG. 3. In other embodiments, additional fields may be added. For instance, the transaction info from the POS system may not include account holder information. To be able to put $$ back on someone's card, you need to know who the card holder was. However, each time a CC is swiped, the CC processor generates a non-PII authorization ID. That code may be transmitted to the credit card issuer from which they can tell exactly who the account holder was and put the $$ onto that card.

### IV. The Platform Benefits Product Sales

With the platform disclosed herein, merchants and brands may target product-level campaigns and promotions directly at consumers, giving them an incentive to buy at local stores. Moreover, the incentive will overcome the issues with a) ad campaigns (no trackability) and b) traditional rebate programs (eliminating paper and funding their credit card directly) while requiring no action on the consumer's part once they purchase a qualifying product. Instead of relying on poorly targeted co-op funds and leaving it up to them to effectively promote the brand's products, brands can now take control by targeting consumers with a post-sale offer, while driving sales into authorized dealers to preserve channel relationships. Additionally, retailers who opt-in to the program will see larger basket sizes, increased category growth and more sales as a result without having to lower prices at retail. Card partners will see accelerated impact of their cash-back rewards and card-linked offer programs and more sales on their cards.

### V. Computer Environment for Implementing the Power Offers Platform

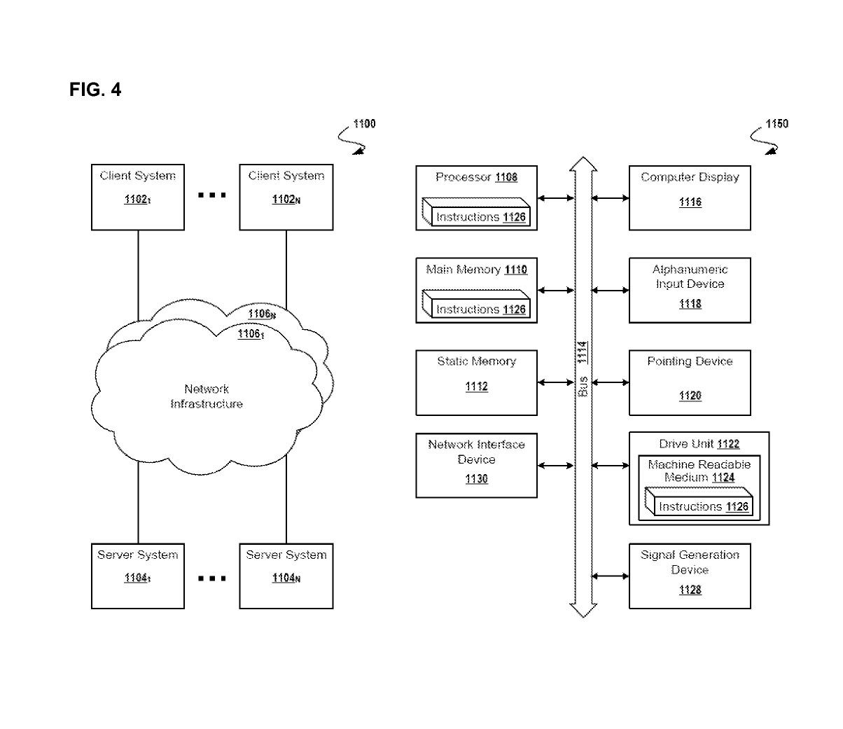

FIG. 4 is a block diagram 1100 of a computer system for implementing embodiments of the platform. The computer system includes nodes for client computer systems 1102₁ through 1102_{N}, nodes for server computer systems 1104₁ through 1104_{N}, and nodes for network infrastructure 1106₁ through 1106_{N}, any of which nodes may comprise a machine (e.g. computer 1150) within which a set of instructions for causing the machine to perform any one of the techniques discussed above may be executed. The embodiment shown is purely exemplary, and might be implemented in the context of one or more of the figures herein.

Any node of the network may comprise a general-purpose processor, a digital signal processor (DSP), an application specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems (including a processor and memory), a massively parallel computer system, and/or a cloud computer system.

The computer system (e.g. computer 1150) includes a processor 1108 (e.g. a processor core, a microprocessor, a computing device, etc.), a main memory (e.g. computer memory 1110), and a static memory 1112, which communicate with each other via a system bus 1114. The computer 1150 may further include a display unit (e.g. computer display 1116) that may comprise a touch-screen, or a liquid crystal display (LCD), or a light emitting diode (LED) display, or a cathode ray tube (CRT). As shown, the computer system also includes a human input/output (I/O) device 1118 (e.g. a keyboard, an alphanumeric keypad, etc.), a pointing device 1120 (e.g. a mouse, a touch screen, etc.), a drive unit 1122 (e.g. a disk drive unit, a CD/DVD drive, a tangible computer readable removable media drive, an SSD storage device, etc.), a signal generation device 1128 (e.g. a speaker, an audio output, etc.), and a network interface device 1130 (e.g. an Ethernet interface, a wired network interface, a wireless network interface, a propagated signal interface, etc.).

The drive unit 1122 includes a machine-readable medium 1124 on which is stored a set of instructions (i.e. software, firmware, middleware, etc.) 1126 embodying any one, or all, of the methodologies described above. The set of instructions 1126 is also shown to reside, completely or at least partially, within the main memory and/or within the processor 1108. The set of instructions 1126 may further be transmitted or received via the network interface device 1130 over the system bus 1114.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing non-transitory information in a form readable by a machine (e.g. a computer). For example, a machine-readable medium includes read-only memory (ROM); random access memory (RAM); magnetic disk storage media; optical storage media; flash memory devices; and electrical, optical or acoustical or any other type of media suitable for storing non-transitory information.

Although the present invention has been described in terms of specific exemplary embodiments, it will be appreciated that various modifications and alterations might be made by those skilled in the art without departing from the spirit and scope of the invention.

What is claimed is:

1. A computer-implemented method for implementing a promotional offer to a consumer, the method comprising:
communicating a promotional offer to a consumer to receive value based on terms of sale of a specific product offered for sale by a seller;
targeting the consumer, through a provider of a financial service of the consumer, including communicating the promotional offer to the consumer;
receiving point of sale data from the seller that sells the product;
determining, from the point of sale data from the seller, one or more transactions for which consumers purchased the product using the financial service that qualify for the value; and
issuing an indication that the transaction qualifies for the value of the promotional offer.

2. The computer-implemented method as set forth in claim 1, wherein a SKU number identifies the product.

3. The computer-implemented method as set forth in claim 1, wherein the financial service comprises a credit card.

4. The computer-implemented method as set forth in claim 1, wherein the financial service comprises an online payment system.

5. The computer-implemented method as set forth in claim 1, wherein the seller comprises a retailer that sells the product to the consumer at a physical location.

6. The computer-implemented method as set forth in claim 1, wherein the seller comprises an e-tailer that sells the product to the consumer over the Internet.

7. The computer-implemented method as set forth in claim 1, wherein issuing an indication that the transaction qualifies for the value of the promotional offer comprises:
communicating to the provider of the financial service information about the transaction; and
crediting, by the provider of the financial service, the amount of the value of the promotional offer to an account of the consumer if the consumer qualifies.

8. The computer-implemented method as set forth in claim 1, wherein receiving the point of sale data from the seller comprises receiving point of sale data from the seller in real time, further comprising:
determining, in real time from the point of sale data, whether one or more transactions qualify for the value; and
sending to the seller an amount to award the consumer at the point of sale for the purchase of the transaction if the transaction qualifies.

9. The computer-implemented method as set forth in claim 1, wherein receiving the point of sale data from the seller comprises receiving point of sale data from the seller in a batch, further comprising:
scanning the point of sale data to identify transactions that qualify for the value; and
generating validation data that identifies transactions that qualify for the value.

10. The computer-implemented method as set forth in claim 9, wherein generating validation data comprises generating validation data that identifies, for a transaction that qualifies, a purchase amount, the time and date and an authorization ID from the provider of the financial service.

11. The computer-implemented method as set forth in claim 7, wherein generating validation data comprises generating validation data that identifies, for a transaction that qualifies, a purchase amount, the time and date and the consumer.

12. The computer-implemented method as set forth in claim 1, wherein crediting, by the provider of the financial service, the amount of the value of the promotional offer to an account of the consumer if the consumer qualifies comprises crediting the value to a credit card of the consumer.

13. The computer-implemented method as set forth in claim 1, wherein crediting, by the provider of the financial service, the amount of the value of the promotional offer to an account of the consumer if the consumer qualifies comprises crediting the value to an online payment account of the consumer.

14. The computer-implemented method as set forth in claim 1, further comprising funding the value jointly by the provider of the financial service and a manufacturer of the product.

15. The computer-implemented method as set forth in claim 1, further comprising determining whether a retailer opted-in to participate in the program.

16. The computer-implemented method as set forth in claim 1, further comprising:
determining, at the provider of the financial service, the identify of the consumer from the information about the transaction; and
determining an account number of the consumer associated with the financial service.

17. The computer-implemented method as set forth in claim 1, wherein targeting the consumer, through a provider of a financial service of the consumer, comprises targeting consumers by demographics.

18. A computer-readable medium comprising a plurality of instructions, which when executed by a computer, cause the computer to implement a promotional offer to a consumer, the instructions for:
communicating a promotional offer to a consumer to receive value based on terms of sale of a specific product offered for sale by a seller;
targeting the consumer, through a provider of a financial service of the consumer, including communicating the promotional offer to the consumer;
receiving point of sale data from the seller that sells the product;
determining, from the point of sale data from the seller, one or more transactions for which consumers purchased the product using the financial service that qualify for the value; and
issuing an indication that the transaction qualifies for the value of the promotional offer.

19. The computer-readable medium as set forth in claim 18, wherein a SKU number identifies the product.

20. The computer-readable medium as set forth in claim 18, wherein the financial service comprises a credit card.
